(19) United States
(12) Patent Application Publication
(10) Pub. No.: US 2014/0311882 A1
(43) Pub. Date: Oct. 23, 2014

(54) Switch

(71) Applicants: Toshihiko Terashita, Tokyo (JP); Tomoaki Sakaguchi, Tokyo (JP)

(72) Inventors: Toshihiko Terashita, Tokyo (JP); Tomoaki Sakaguchi, Tokyo (JP)

(73) Assignee: MITSUMI ELECTRIC CO., LTD., Tokyo (JP)

(21) Appl. No.: 14/254,338

(22) Filed: Apr. 16, 2014

(30) Foreign Application Priority Data
Apr. 19, 2013 (JP) 2013-088439

(51) Int. Cl. H01H 13/10

(52) U.S. Cl. CPC H01H 13/10; H01H 2203/036
USPC 200/520

(57) ABSTRACT

A switch includes an insulating case, a fixed electrode and a movable electrode. The insulating case is formed with an operating space therein. At least a part of the fixed electrode is disposed in the operating space. The movable electrode is disposed in the operating space, and is configured to be engaged with and disengaged from the part of the fixed electrode. A flat surface of the insulating case and a flat surface of the fixed electrode, which are located in outermost positions in a predetermined side of the insulating case, form a plane in corporation with each other.

### BACKGROUND

The present invention relates to a switch mounted on, for instance, a circuit board.

As a switch of this kind, a switch is known which includes a case, a fixed electrode and a movable electrode. The case defines an operating space and a part of the fixed electrode is arranged in the operating space. The movable electrode is arranged in the operating space so as to be engaged with and disengaged from the part of the fixed electrode (see Patent Literature 1). Another part of the fixed electrode is exposed outside the case. When the switch is mounted on the circuit board, the exposed part is electrically connected to a wiring formed on the circuit board.

As a switch which has the above-described structure and is available at present, there is a switch which has a length and width dimension of several mm or so and a thickness dimension of about 0.5 mm. With a progress of miniaturization of an electronic device on which the switch is mounted, the switch itself is requested to be more miniaturized. Especially, in the direction of thickness of the switch (a normal direction of the circuit board in the above-described example), a request for a miniaturized form (a thinned form) is high.
[Patent Literature 1] JP-A-2012-104416

### SUMMARY

It is therefore one advantageous aspect of the present invention to provide a switch which has a more miniaturized form, especially, a thinned form.

According to one aspect of the invention, there is provided a switch comprising:

an insulating case formed with an operating space therein;

a fixed electrode, at least a part of which being disposed in the operating space; and

a movable electrode, disposed in the operating space, and configured to be engaged with and disengaged from the part of the fixed electrode,

wherein a flat surface of the insulating case and a flat surface of the fixed electrode, which are located in outermost positions in a predetermined side of the insulating case, form a plane in corporation with each other.

The switch may be configured such that: the operating space is defined by a through hole opened in the predetermined side of the insulating case; and an insulating cover is attached to the plane and covers the through hole.

The switch may be configured such that: the cover has an adhesive surface stuck to the plane; and the adhesive surface is exposed to the through hole.

The cover may be formed with a heat resistant film.

The part of the fixed electrode may be formed with a hole.

The hole of the fixed electrode may pass through the fixed electrode.

The switch may be configured such that: the fixed electrode includes a first electrode and a second electrode; the movable electrode includes a first part which is configured to be engaged with and disengaged from the first electrode and a second part which is configured to come into contact with the second electrode; and the case includes a protruding part which extends between the movable electrode and the first electrode from a wall which defines the operating space.

According to another aspect of the invention, there is provided a switch comprising:

an insulating case formed with an operating space therein;

a fixing projection provided on a surface of the insulating case;

a fixed electrode including a contact part which is disposed in the operating space and a fixed part which is disposed on the surface of the insulating case; and

a movable electrode, disposed in the operating space, and configured to be engaged with and disengaged from the contact part of the fixed electrode,

wherein an edge of the fixed part at a side opposite to the surface of the insulating case has a chamfered portion, and

wherein the fixing projection is engaged with the chamfered portion.

The switch may be configured such that: the fixed part includes a through hole; and a peripheral edge of the through hole has the chamfered portion so that the through hole is expanded toward the side opposite to the surface of the insulating case.

The fixing projection may be integrally molded with the insulating case.

An insulating film may be attached on the fixed electrodes at the side opposite to the surface of the insulating case.

### BRIEF DESCRIPTION OF DRAWINGS

FIG. 1 is an exploded perspective view showing a structure of a switch according to one exemplary embodiment of the present invention.

FIGS. 2A and 2B are perspective views showing a first conductive member and a second conductive member shown by the switch.

FIGS. 3A and 3B are perspective views showing an external appearance of the switch.

FIGS. 4A to 4D are four face views showing the external appearance of the switch.

FIG. 5 is a sectional view taken along a line V-V in FIG. 4A.

FIG. 6 is a sectional view showing a part of a case provided in the switch which is enlarged.

FIG. 7 is an exploded perspective view showing a structure of a lower surface side of the switch.

FIGS. 8A and 8B are partly sectional views showing a state of the switch mounted on a circuit board.

### DETAILED DESCRIPTION OF EXEMPLIFIED EMBODIMENTS

Referring to the attached drawings, an exemplary embodiment according to the present invention will be described below in detail. In the drawings respectively used in the below-described explanation, a scale is suitably changed so that members may have respectively recognizable sizes. Further, expressions of “front”, “rear”, “right”, “left”, “upper” and “lower” are used for the convenience of explanation and do not restrict positions or directions in actually using states.

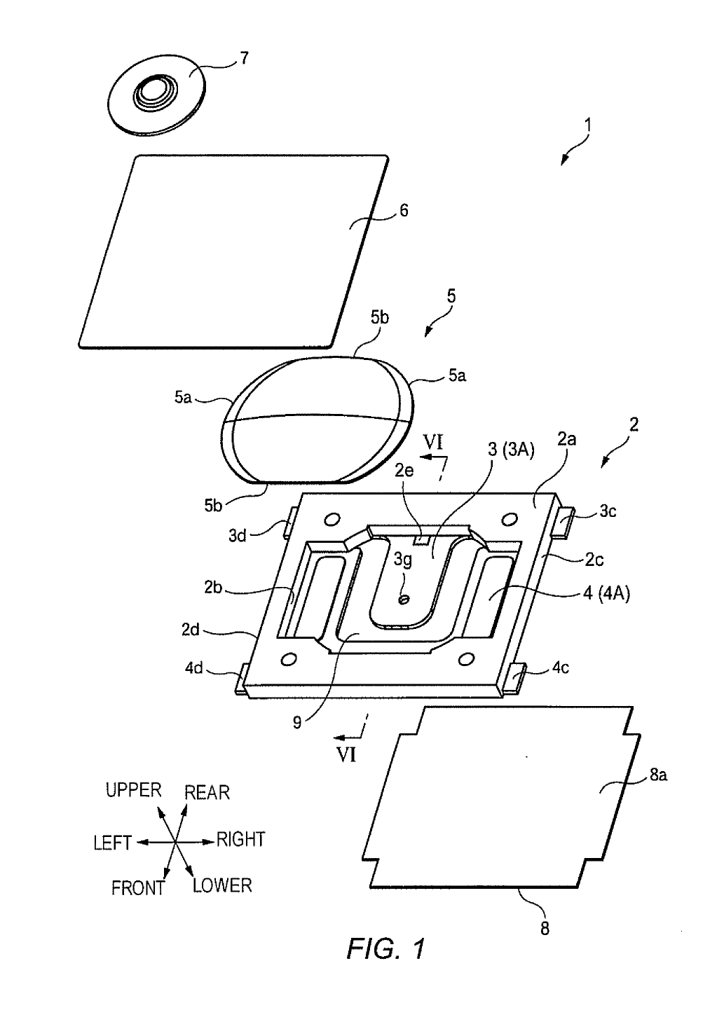

FIG. 1 is an exploded perspective view showing a structure of a push switch 1 (one example of a switch) according to one exemplary embodiment of the present invention. The push switch 1 includes a case 2, a first conductive member 3, a second conductive member 4, a movable electrode 5, an upper cover 6, a push member 7 and a lower cover 8.

The case 2 is formed with an insulating material such as a resin. The case 2 has a through hole 2b defined by a peripheral wall 2a. The first conductive member 3 and the second conductive member 4 are formed with an electrically conductive material such as copper. The first conductive member 3 and the second conductive member 4 are molded integrally with the case 2 by, for instance, an insert molding.

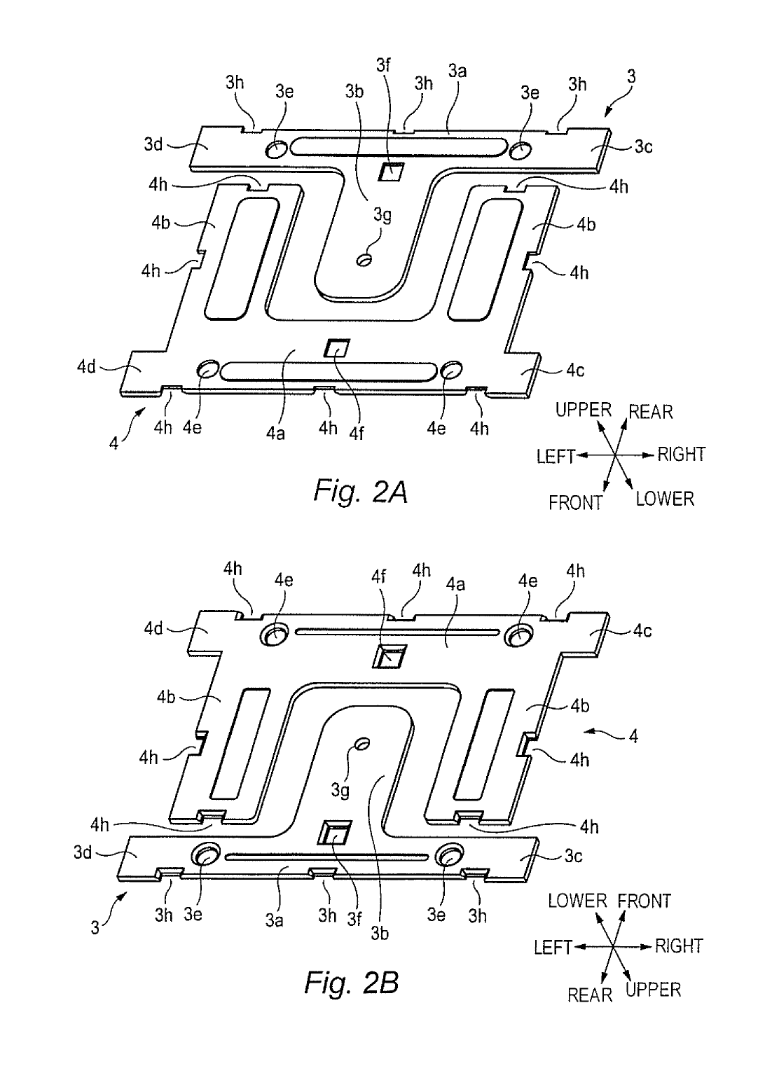

FIG. 2A is a perspective view of the first conductive member 3 and the second conductive member 4 which are viewed from an upper part. FIG. 2B is a perspective view of the first conductive member 3 and the second conductive member 4 which are viewed from a lower part.

The first conductive member 3 includes a first part 3a which extends in a transverse direction and a second part 3b which extends forward from a central part of the first part 3a. The first part 3a is buried in the peripheral wall 2a of the case 2 except a right end part 3c and a left end part 3d thereof. Thus, as shown in FIG. 1, the right end part 3c and the left end part 3d are respectively exposed in a right side wall 2c and a left side wall 2d of the case 2 and function as outer terminals. Further, the second part 3b is arranged in the through hole 2b in the form of a cantilever and functions as a first fixed electrode. In the following description, the second part 3b is referred to as a “first fixed electrode 3A” as required.

The second conductive member 4 includes a first part 4a which extends in a transverse direction and a pair of second parts 4b which extend rearward in end sides from a central part of the first part 4a. A front side part except a right end part 4c and a left end part 4d of the first part 4a and outside parts of the second parts 4b in a transverse direction are buried in the peripheral wall 2a of the case 2. Thus, as shown in FIG. 1, the right end part 4c and the left end part 4d are respectively exposed in the right side wall 2c and the left side wall 2d of the case 2 and function as outer terminals. Further, a rear side part of the first part 4a and inside parts of the second parts 4b in the transverse direction are arranged in the through hole 2b and function as a second fixed electrode. In the following description, these parts are generally referred to as a “second fixed electrode 4A” as required.

In the first part 3a of the first conductive member 3, round through holes 3e are formed. In the second part 3b of the first conductive member 3, a rectangular through hole 3f is formed in the vicinity of a base end part thereof and a circular through hole 3g is formed in the vicinity of an end part. The through holes 3e and 3f are holes through which the resin is allowed to flow when the first conductive member 3 is molded integrally with the case 2. As shown in FIG. 2B, in a lower surface side of the first conductive member 3, opening edges of the through holes 3e and 3f are chamfered so that the holes are respectively expanded toward the lower surface. Thus, the resin which enters the holes and is hardened functions as a slip-out stopper to prevent the first conductive member 3 from falling downward from the case 2. A role of the through hole 3g will be described below.

Fixing projection 2g formed by the resin which enters the through hole 3f is provided on the lower surface of the case 2. The peripheral edge of the through hole 3f at a side opposite to the lower surface of the case 2 has a chamfered portion. The fixing projection 2g is engaged with the chamfered portion of the through hole 3f respectively. Similar fixing projections (not shown) formed by the resin which enters the through holes 3e are also provided on the lower surface of the case 2 and is engaged with a chamfered portion of each of the through holes 3e.

In a rear end edge of the first part 3a, a plurality of cut-out parts 3h are formed. The cut-out parts 3h form spaces through which the resin is allowed to flow when the first conductive member 3 is molded integrally with the case 2. As shown in FIG. 2B, in the lower surface side of the first conductive member 3, opening edges of the cut-out parts 3h are chamfered so as to be respectively expanded toward the lower surface. Thus, the resin which enters the cut-out parts 3h respectively and is hardened functions as a slip-out stopper to prevent the first conductive member 3 from falling downward from the case 2.

Fixing projections 2h formed by the resin which enters the cut-out parts 3h are provided on the lower surface of the case 2. The opening edge of each of the cut-out parts 3h at a side opposite to the lower surface of the case 2 has a chamfered portion. The fixing projections 2h are engaged with the chamfered portions of the cut-out parts 3h respectively.

In the first part 4a of the second conductive member 4, circular through holes 4e and a rectangular through hole 4f are formed. The through holes 4e and 4f are holes through which the resin is allowed to flow when the second conductive member 4 is molded integrally with the case 2. As shown in FIG. 2B, in a lower surface side of the second conductive member 4, opening edges of the through holes 4e and 4f are chamfered so that the holes are respectively expanded toward the lower surface. Thus, the resin which enters the through holes and is hardened functions as a slip-out stopper to prevent the second conductive member 4 from falling downward from the case 2.

Fixing projections (not shown) formed by the resin which enters the through holes 4e are provided on the lower surface of the case 2. The peripheral edge of each of the through holes 4e at a side opposite to the lower surface of the case 2 has a chamfered portion. The fixing projections corresponding to the through holes 4e are engaged with the chamfered portion of the through holes 4e respectively. Similar fixing projection (not shown) formed by the resin which enters the through holes 4f is also provided on the lower surface of the case 2 and is engaged with a chamfered portion of the through hole 4f.

In a peripheral edge of the second conductive member 4, a plurality of cut-out parts 4h are formed. The cut-out parts 4h form spaces through which the resin is allowed to flow when the second conductive member 4 is molded integrally with the case 2. As shown in FIG. 2B, in the lower surface side of the second conductive member 4, opening edges of the cut-out parts 4h are chamfered so as to be respectively expanded toward the lower surface. Thus, the resin which enters the cut-out parts 4h respectively and is hardened functions as a slip-out stopper to prevent the second conductive member 4 from falling downward from the case 2.

Fixing projections (not shown) formed by the resin which enters the cut-out parts 4h are provided on the lower surface of the case 2. The opening edge of each of the cut-out parts 4h at a side opposite to the lower surface of the case 2 has a chamfered portion. The fixing projections corresponding to the cut-out parts 4h are engaged with the chamfered portions of the cut-out parts 3h respectively.

In such a way, since the first conductive member 3 and the second conductive member 4 are molded or formed integrally with the case 2, as shown in FIG. 1, a cavity 9 having no bottom is formed between the first fixed electrode 3A and the second fixed electrode 4A in an inner part of the through hole 2b.

The movable electrode 5 is formed with the conductive material such as copper. The movable electrode 5 includes a pair of first edge parts 5a which are bent in right and left end parts and extend forward and backward and second edge parts 5b which extend in a transverse direction in front and rear end parts. The movable electrode 5 is arranged in the through hole 2b of the case 2 so that the first edge parts 5a are mounted on the second fixed electrode 4A.

The upper cover 6 is formed with an insulating material having flexibility. As an example of the material, is exemplified a film of polyimide or polyether ketone having an acrylic adhesive surface formed. The adhesive surface is stuck to an upper surface of the peripheral surface 2a of the case 2, so that an upper side opening part of the through hole 2b is closed.

The push member 7 is stuck to a central part of an upper surface of the upper cover 6 by a suitable method. The push member 7 is formed with a suitable material having rigidity.

The lower cover 8 is formed with an insulating material having a heat resisting property. As an example of the material, is exemplified a polyimide film having an acrylic adhesive surface 8a formed. The adhesive surface 8a is stuck to a lower surface of the peripheral wall 2a of the case 2, so that a lower side opening part of the through hole 2b is closed.

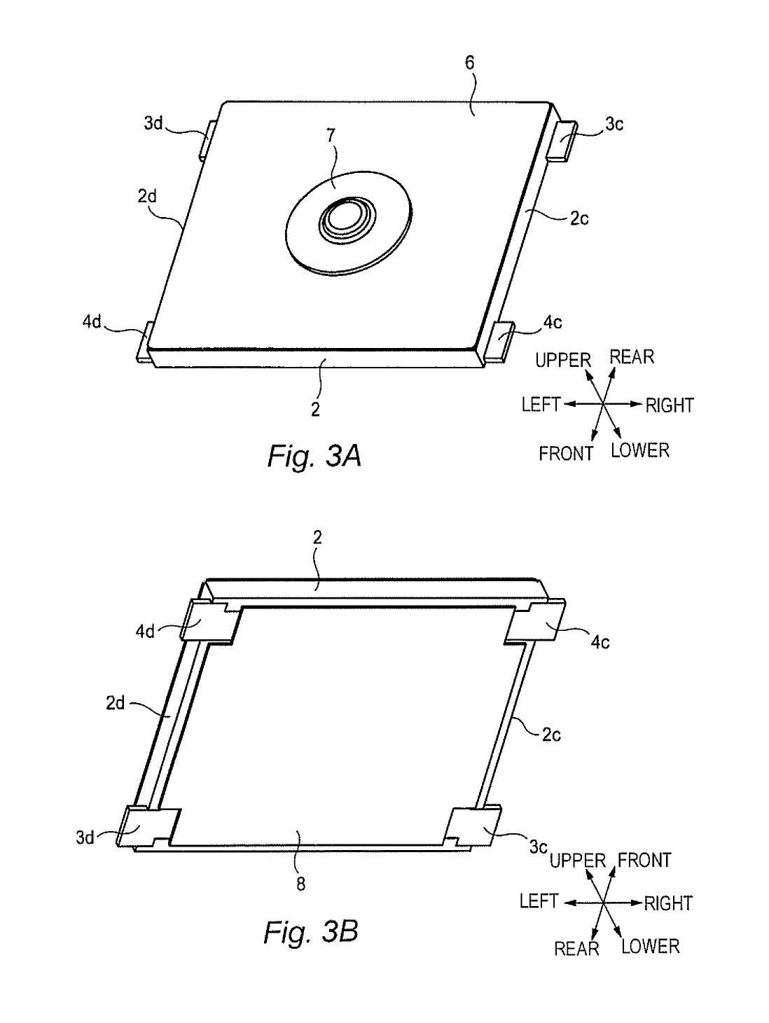

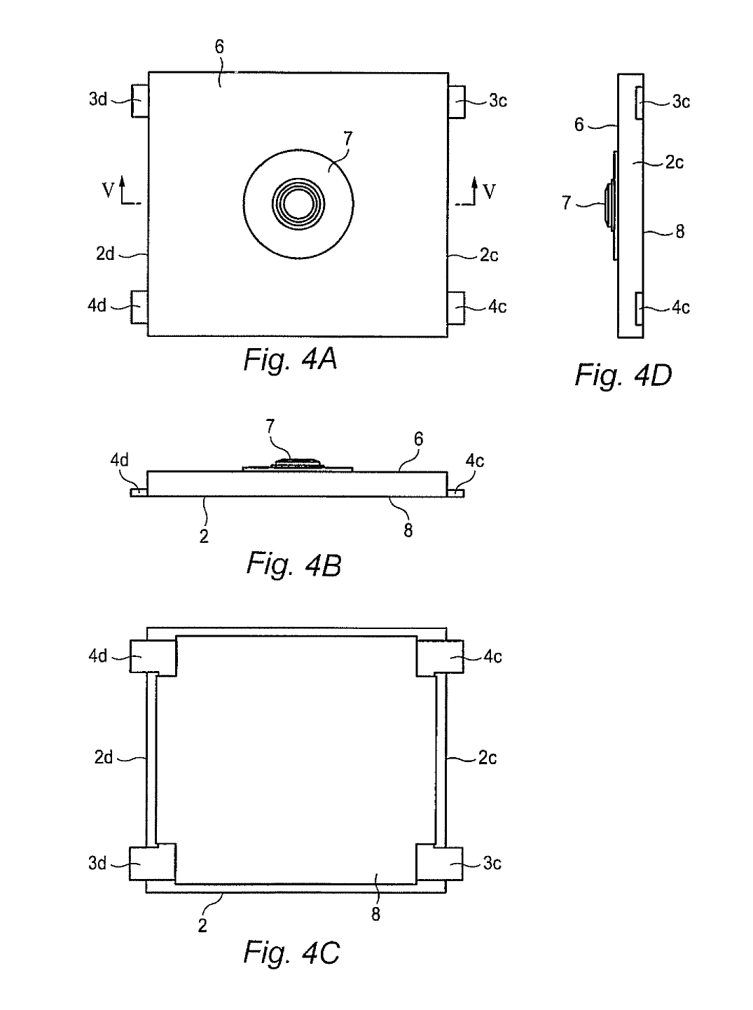

FIGS. 3A to 4D are views showing an external appearance of the push switch 1 assembled in such a way as described above. FIG. 3A is a perspective view seen from an upper part and FIG. 3B is a perspective view seen from a lower part. FIG. 4A is a top view. 4B is a front view. FIG. 4C is a bottom view. FIG. 4D is a right side view. Since a rear view and a left side view respectively appear symmetrically with the front view and the right side view, an illustration of them are omitted.

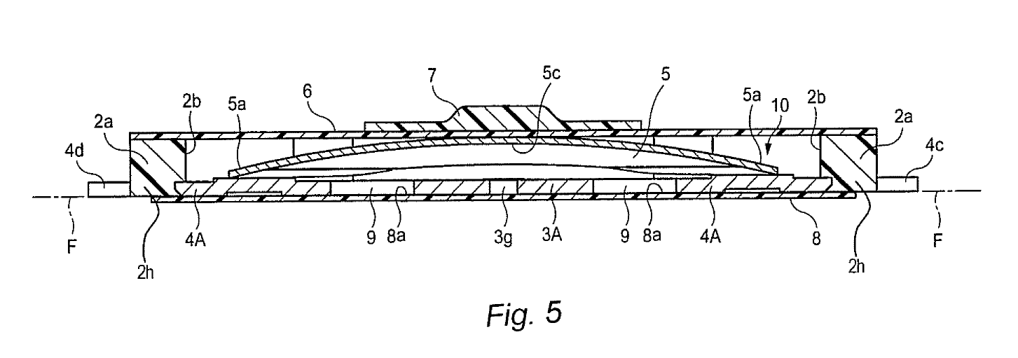

FIG. 5 is a sectional view taken along a line V-V in FIG. 4A. The upper side opening part of the through hole 2b of the case 2 is closed by the upper cover 6 and the lower side opening part is closed by the lower cover 8, so that an operating space 10 is formed. In an inner part of the operating space 10, the first fixed electrode 3A, the second fixed electrode 4A and the movable electrode 5 are arranged. The adhesive surface 8a of the lower cover 8 is exposed in the operating space 10 through the through hole 3g formed in the first fixed electrode 3A and the cavity 9 formed between the first fixed electrode 3A and the second fixed electrode 4A.

The movable electrode 5 is formed in the shape of a dome protruding upward. Under a state that a load is not applied to the push member 7, a central part 5c of the movable electrode 5 is separated from the first fixed electrode 3A. Namely, the first fixed electrode 3A is not electrically conducted to the second fixed electrode 4A.

When the load of a prescribed value or larger is applied to the push member 7 from an upper part, the central part 5c of the movable electrode 5 is deformed downward to come into contact with the first fixed electrode 3A. Namely, the first fixed electrode 3A is electrically conducted to the second fixed electrode 4A. The through hole 3g of the first fixed electrode 3A is formed at a position on which the central part 5c of the deformed movable electrode 5 abuts.

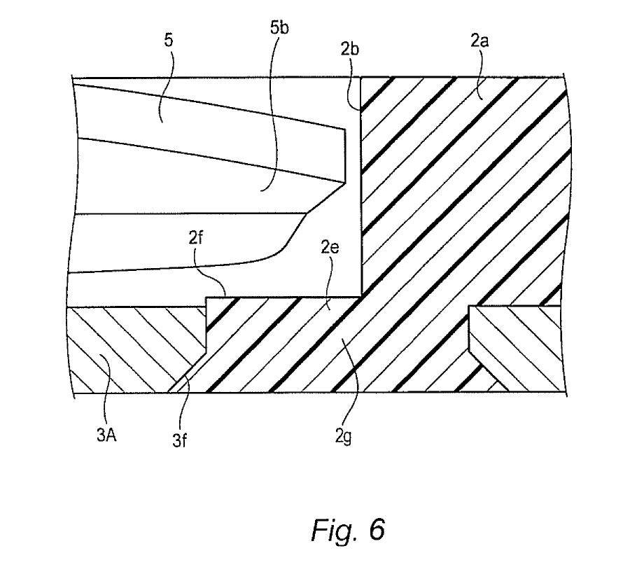

As shown in FIG. 1, an inner peripheral surface of the peripheral wall 2a of the case 2 has a protruding part 2e which extends toward the through hole 2b. FIG. 6 is a sectional view showing that part which is enlarged along arrow marks VI-VI. The protruding part 2e is formed above the rectangular through hole 3f formed in the second part 3b of the first conductive member 3. The protruding part 2e forms a small stepped part 2f relative to an upper surface of the first conductive member 3. A height of the stepped part 2f is set to such a height at which the upper surface of the protruding part 2e does not come into contact with the second edge part 5b of the movable electrode 5 when the load is not applied.

A protruding part having the same structure as that described above, an illustration of which is omitted, is also formed above the rectangular through hole 4f formed in the first part 4a of the second conductive member 4.

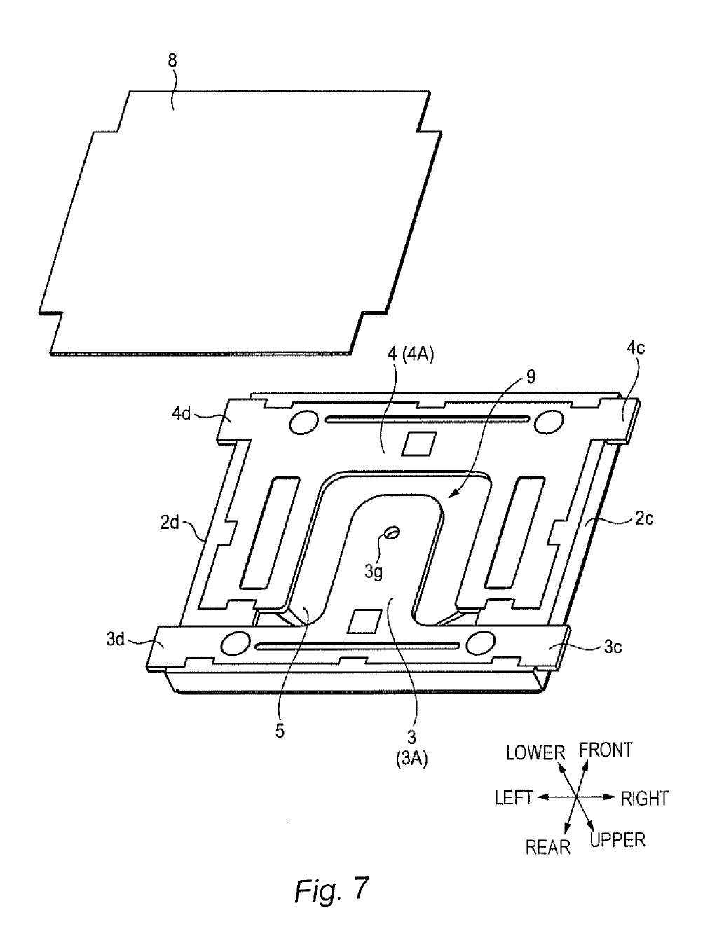

FIG. 7 is an exploded perspective view showing a lower surface side of the case 2 under a state that the lower cover 8 is detached. The lower surfaces of the first fixed electrode 3A and the second fixed electrode 4A are exposed in the lower side of the case 2. As shown in FIG. 5, in the case 2, the first fixed electrode 3A and the second fixed electrode 4A, flat surfaces located in outermost sides in the lower side of the case 2 form the same plane F. The adhesive surface 8a of the lower cover 8 is allowed to adhere to the plane so that the through hole 2b is covered with the lower cover 8.

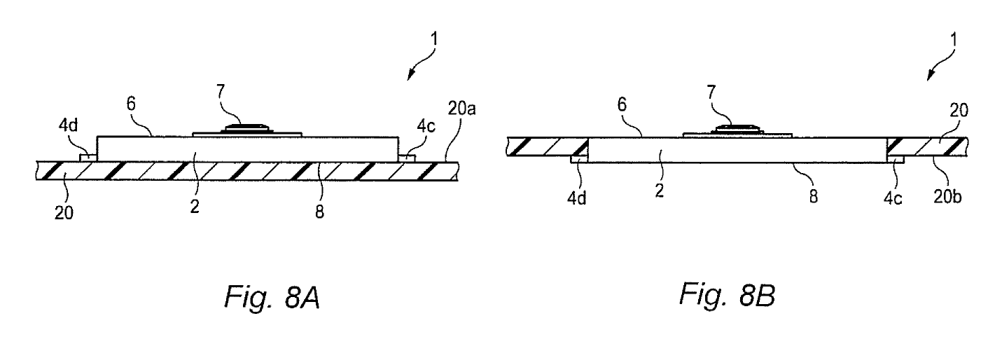

As shown in FIGS. 8A and 8B, the push switch 1 is mounted on, for instance, a circuit board 20 and the outer terminals (the right end part 3c and the left end part 3d of the first conductive member 3 and the right end part 4c and the left end part 4d of the second conductive member 4) are electrically connected to a wiring by soldering. FIG. 8A shows a case that the outer terminals are mounted on an upper surface 20a of the circuit board 20. FIG. 8B shows a case that the push switch 1 is inserted into an insert hole formed in the circuit board 20 and the outer terminals are mounted on a lower surface 20b of the circuit board 20.

According to the structure of the present exemplary embodiment, the case 2 defines the operating space 10. The first fixed electrode 3A, the second fixed electrode 4A and the movable electrode 5 are arranged in the operating space 10. The movable electrode 5 is engaged with and disengaged from the first fixed electrode 3A. Here, in the case 2, the first fixed electrode 3A and the second fixed electrode 4A, the flat surfaces located in the outermost sides in the lower side (one example of the prescribed side) of the case 2 form the same plane F. In other words, a part of the case 2 is not located below the lower side flat surfaces of the first fixed electrode 3A and the second fixed electrode 4A. Accordingly, a dimension of the push switch 1 in a vertical direction can be reduced (thinned). For instance, in any case shown in FIGS. 8A and 8B, since a dimension of the circuit board 20 in a normal direction can be reduced, a device on which the push switch 1 is mounted can be miniaturized. Further, since the resin forming the case 2 does not need to be turned below the first fixed electrode 3A and the second fixed electrode 4A, a structure of a metal mold can be simplified. Thus, a quantity of the resin to be used can be reduced and a production cost can be reduced at the same time.

According to the structure of the present exemplary embodiment, the operating space 10 is defined by the through hole 2b formed in the case 2. Thus, an opening surface of the thorough hole 2b in the lower side of the case 2 can be set as the flat surface located in the outermost side in the lower side, so that the switch can be more thinned. As an example of a numeric value, while a dimension of thickness of a usual push switch (excluding a push member 7) is 0.46 mm, the push switch of the present invention can be thinned up to 0.36 mm (namely, 20% or more).

Since the insulating lower cover 8 is attached to the lower surface of the case 2 to cover the through hole 2b, the first fixed electrode 3A and the second fixed electrode 4A exposed in the lower side of the case 2 in the through hole 2b can be electrically insulated from an external part and water or dust can be prevented from entering the operating space 10.

According to the structure of the present exemplary embodiment, since the lower cover 8 is formed with the heat resistant film, the push switch 1 is not restrained from being thinned. As an example of a numeric value, when the lower cover is molded by the resin, a thickness of 0.08 to 0.1 mm is necessary to permit the resin to flow. However, when the lower cover 8 is formed with the heat resistant film, the thickness may be set to 0.02 to 0.05 mm. Further, the push switch 1 is mounted on the circuit board 20 by soldering, heat damage can be avoided.

According to the structure of the present exemplary embodiment, the through hole 3g is formed in the first fixed electrode 3A. The through hole 3g is formed at a position with which the central part 5c of the movable electrode 5 deformed by operating the push member 7 comes into contact. Thus, the central part 5c of the movable electrode 5 comes into linear contact with an edge part of the through hole 3g. As compared with a case that the through hole 3g is not formed and the movable electrode 5 is allowed to come into point contact with the first fixed electrode 3A, contact stability can be improved.

When engagements and disengagements of the movable electrode 5 and the first fixed electrode 3A are repeated many times, black powder is generated. According to the structure of the present exemplary embodiment, the adhesive surface 8a of the lower cover 8 is exposed in the through hole 2b. Thus, the generated black powder can be captured by the adhesive surface 8a. Accordingly, when the black powder moves in the operating space 10, the contact resistance can be prevented from being unstable.

According to the structure of the present exemplary embodiment, the through hole 3g is formed at the part where the movable electrode 5 comes into contact with the first fixed electrode 3A and the adhesive surface 8a of lower cover 8 is also exposed to a lower part of the through hole 3g. Accordingly, the generated black powder can be prevented from staying in the contact part of the movable electrode 5 and the first fixed electrode 3A. Further, the generated black powder can be efficiently captured.

The movable electrode 5 includes the central part 5c (one example of a first part of a movable electrode) which is engaged with and disengaged from the first fixed electrode 3A (one example of a first electrode) and the first edge parts 5a (one example of a second part of the movable electrode) which come into contact with the second fixed electrode 4A (one example of a second electrode). The protruding part 2e of the case 2 extends between the second edge part 5b of the movable electrode 5 and the first fixed electrode 3A from the peripheral wall 2a which defines the operating space 10.

According to such a structure, can be prevented a situation that a vibration or impact is applied to the push switch 1 so that the second edge part 5b of the movable electrode 5 comes into contact with the first fixed electrode 3A to unexpectedly conduct the first fixed electrode 3A to the second fixed electrode 4A. The second edge part 5b of the movable electrode 5 comes into contact with the insulating protruding part 2e before coming into contact with the first fixed electrode 3A.

The above-described exemplary embodiment is made in order to easily understand the present invention and is not limit the present invention. It is to be understood that the present invention may be changed or improved without deviating from a gist thereof and equivalences thereof may be included in the present invention.

The case 2 does not necessarily need to define the operating space 10 by the through hole 2b. As long as the flat surfaces of the case 2, the first fixed electrode 3A and the second fixed electrode 4A located in the outermost sides in the lower side of the case 2 form the same plane, the operating space 10 may be defined by, for instance, a recessed part formed in the case 2. In this case, the first fixed electrode 3A and the second fixed electrode 4A are partly arranged in the operating space 10.

The upper cover 6 and the lower cover 8 are not necessarily films having the adhesive surfaces. For instance, a nylon film may be used and attached to the case 2 by a laser welding.

The push member 7 as a separate member does not necessarily need to be stuck to the upper cover 6. A member may be used which is obtained in such a way that a sheet type part and a part functioning as a push member are integrally molded with a thermoplastic resin.

The through hole 3g formed in the contact part of the first fixed electrode 3A and the movable electrode 5 may be formed as a hole having a bottom as long as a linear contact between them can be ensured.

As long as the movable electrode is provided which is engaged with and disengaged from the fixed electrode arranged in the operating space 10, the switch is not limited to the push switch 1. The present invention may be applied to, for instance, a slide switch.

What is claimed is:

1. A switch comprising:
an insulating case formed with an operating space therein;
a fixed electrode, at least a part of which being disposed in the operating space; and
a movable electrode, disposed in the operating space, and configured to be engaged with and disengaged from the part of the fixed electrode,
wherein a flat surface of the insulating case and a flat surface of the fixed electrode, which are located in outermost positions in a predetermined side of the insulating case, form a plane in corporation with each other.

2. The switch as set forth in claim 1, wherein
the operating space is defined by a through hole opened in the predetermined side of the insulating case, and
an insulating cover is attached to the plane and covers the through hole.

3. The switch as set forth in claim 2, wherein
the cover is formed with a heat resistant film.

4. The switch as set forth in claim 2, wherein
the cover has an adhesive surface stuck to the plane, and
the adhesive surface is exposed to the through hole.

5. The switch as set forth in claim 1, wherein
the part of the fixed electrode is formed with a hole.

6. The switch as set forth in claim 5, wherein
the hole of the fixed electrode passes through the fixed electrode.

7. The switch as set forth in claim 1, wherein
the fixed electrode includes a first electrode and a second electrode,
the movable electrode includes a first part which is configured to be engaged with and disengaged from the first electrode and a second part which is configured to come into contact with the second electrode, and
the case includes a protruding part which extends between the movable electrode and the first electrode from a wall which defines the operating space.

8. A switch comprising:
an insulating case formed with an operating space therein;
a fixing projection provided on a surface of the insulating case;
a fixed electrode including a contact part which is disposed in the operating space and a fixed part which is disposed on the surface of the insulating case; and
a movable electrode, disposed in the operating space, and configured to be engaged with and disengaged from the contact part of the fixed electrode,
wherein an edge of the fixed part at a side opposite to the surface of the insulating case has a chamfered portion, and
wherein the fixing projection is engaged with the chamfered portion.

9. The switch as set forth in claim 8, wherein
the fixed part includes a through hole, and
a peripheral edge of the through hole has the chamfered portion so that the through hole is expanded toward the side opposite to the surface of the insulating case.

10. The switch as set forth in claim 8, wherein
the fixing projection is integrally molded with the insulating case.

11. The switch as set forth in claim 8, further comprising:
an insulating film is attached on the fixed electrodes at the side opposite to the surface of the insulating case.
